(19) United States
(12) Patent Application Publication
(10) Pub. No.: US 2020/0243813 A1
(43) Pub. Date: Jul. 30, 2020

(54) COMPACT BATTERY-BASED ENERGY STORAGE

(71) Applicant: Sinexcel, Inc., Palo Alto, CA (US)

(72) Inventors: Junheng Zhang, Palo Alto, CA (US); Ran Gao, Palo Alto, CA (US); Xiaobo Fan, Palo Alto, CA (US); Chenglei Wang, Palo Alto, CA (US); Song Chen, Palo Alto, CA (US); Ming Xie, Palo Alto, CA (US); Yingchuan Li, Palo Alto, CA (US); Jibo Zhang, Palo Alto, CA (US)

(73) Assignee: Sinexcel, Inc., Palo Alto, CA (US)

(21) Appl. No.: 16/261,397

(22) Filed: Jan. 29, 2019

(51) Int. Cl. H01M 2/10; H02J 3/38; H01M 10/42; H01M 10/613; H01M 10/627

(52) U.S. Cl. CPC H01M 2/1077; H02J 3/38; H02J 7/0021; H01M 10/613; H01M 10/627; H01M 10/425

(57) ABSTRACT

Compact battery-based energy storage systems are disclosed. An example battery-based energy storage device includes: an energy storage inverter; a transformer; a fire extinguisher system; a first battery chamber; a second battery chamber, and an air conditioner system that is configured to provide air conditioning to the first battery chamber and the second battery chamber. The first battery chamber and the second battery chamber are separated by a wall structure and each has its independent air conditioning. The dimensions of the battery-based energy storage device are substantially same as those of a standard 20 ft container. The first battery chamber, the second battery chamber, and the wall structure may equal to inner width of the battery-based energy storage. The battery-based energy storage device may also comprise a ventilation opening of battery set at a top of the first battery chamber and/or the second battery chamber.

### TECHNICAL FIELD

The present disclosure generally related to energy storage and more specifically to a special layout and system design of the battery-based energy storage device which is convenient for replacement, maintenance, expansion, and transportation.

### BACKGROUND

Traditionally, battery-based energy storage solutions are used for providing peak shaving and backup power supply. Individual power projects often require their own designs and implementations, increasing cost and complexity, as well as diminishing customizability and inter-connectability.

Technical challenges therefore remain for providing compact and yet customizable battery-based energy storage systems.

### SUMMARY

The technologies described in the present disclosure include battery-based energy storage devices and systems and more specifically to special layout design and system design of the battery-based energy storage device and system.

In some implementations, a battery-based energy storage device includes: an energy storage inverter; a transformer; a fire extinguisher system; a first battery chamber; a second battery chamber, and an air conditioner system that is configured to provide air conditioning to the first battery chamber and the second battery chamber. The first battery chamber and the second battery chamber are separated by a wall structure and each has its independent air conditioning. The dimensions of the battery-based energy storage device are substantially same as those of a standard 20 ft container. The first battery chamber, the second battery chamber, and the wall structure may equal to inner width of the battery-based energy storage.

In some implementations, the dimensions of the battery-based energy storage device are 20 ft×8 ft×8.5 ft.

In some implementations, the first battery chamber, the second battery chamber, and the wall structure equal to inner width of the battery-based energy storage.

In some implementations, the battery-based energy storage device further includes a ventilation opening of battery set at a top of the first battery chamber and/or the second battery chamber.

In some implementations, a depth of the first battery chamber and a depth of the second battery chamber are between 600 mm and 800 mm.

In some implementations, a width of the wall structure is less than 120 mm.

In some implementations, the battery-based energy storage device further includes a heat dissipation of energy storage inverter connected to the energy storage inverter; a heat dissipation of transformer connected to the transformer; a distribution panel of auxiliary system; and an AC wiring connected to the energy storage inverter.

In some implementations, the battery-based energy storage device further includes: a first right side door associated with the second battery chamber; a second right side door associated with the second battery chamber; a first left side door associated with the first battery chamber; a second left side door associated with the first battery chamber; a right side panel door associated with the panel of energy storage inverter; a left side panel door associated with the distribution panel of auxiliary system; and a front side door associated with the heat dissipation of energy storage inverter.

In some implementations, the battery-based energy storage device further includes: an operating portion; and a battery portion, wherein the energy storage inverter, the transformer, the fire extinguisher system, the heat dissipation of energy storage inverter, the heat dissipation of transformer, the distribution panel of auxiliary system, and the AC wiring are set in the operating portion, wherein the first battery chamber, the second battery chamber, and an air conditioner system are set in a battery portion, and wherein the operating portion and the battery portion are air-flow independent.

In some implementations, the battery-based energy storage device further includes: an energy storage system configured to detect a demand of power supply from a power grid, to determine a power string needed, to receive the power string from one or the plurality of battery bank, to invert DC power of the power string from the battery banks to AC power of the energy storage system, and to transform AC power of the energy storage system to AC power of the power grid.

In some implementations, the energy storage system includes: a meter; an energy storage inverter system; and an external transformer.

In some implementations, the meter is configured to detect the demand of the power supply from the power grid and transmit collected data to the energy storage inverter system.

In some implementations, the energy storage inverter system includes: a human machine interface (HMI) and an energy management system (EMS), wherein the energy storage inverter system is configured to receive the power string from one or the plurality of battery bank, to invert the DC power from the battery banks to the AC power, and to transmit the AC power to the external transformer.

In some implementations, the external transformer is configured to transform the AC power from the energy storage inverter system to the AC power of the demand of power grid.

### BRIEF DESCRIPTION OF THE DRAWINGS

FIG. 1 is block diagram illustrating a left-front side perspective view of an example battery-based energy storage device in accordance with some implementations of the present disclosure.

FIG. 2 is block diagram illustrating a right-rear side perspective view of an example battery-based energy storage device in accordance with some implementations of the present disclosure.

FIG. 3 is block diagram illustrating a top perspective view of an example battery-based energy storage device in accordance with some implementations of the present disclosure.

FIG. 4 is block diagram illustrating multi-string topologic of an example energy storage system in accordance with the implementations of the present disclosure.

FIG. 5 is a block diagram illustrating multi-string modules included in an example energy storage system.

The implementations disclosed herein are illustrated by way of example, and not by way of limitation, in the figures of the accompanying drawings. Like reference numerals refer to corresponding parts throughout the drawings.

### DETAILED DESCRIPTION

Compact battery-based energy storage devices and system designs are provided. The technologies described in the present disclosure may provide the following technical advantages.

First, the disclosed technology provides a standardized and compact module of battery storage which is convenient for transportation.

Second, the layout design for a battery chamber in the present disclosure provides better accessibility for operators or maintainers to replace, or expand battery banks, maintain or fix the power transformer, energy storage inverter, fire extinguisher system, or air condition system. Also, the non-walk-in design reduces the risk of trapping operators or maintainers in the container of the battery storage.

Third, the multi-string technology in the present disclosure may provide an expandable battery-based energy storage system. The end user may choose to install a smaller volume of energy system for the first step. Once they have higher power and energy demand to install more, they may just add up with new battery banks and inverter modules, without concerning the mixing-up of new and pre-installed battery banks.

Fourth, a space design of battery bank container enables energy saving since two containers are separate and with independent air conditioner and air flow.

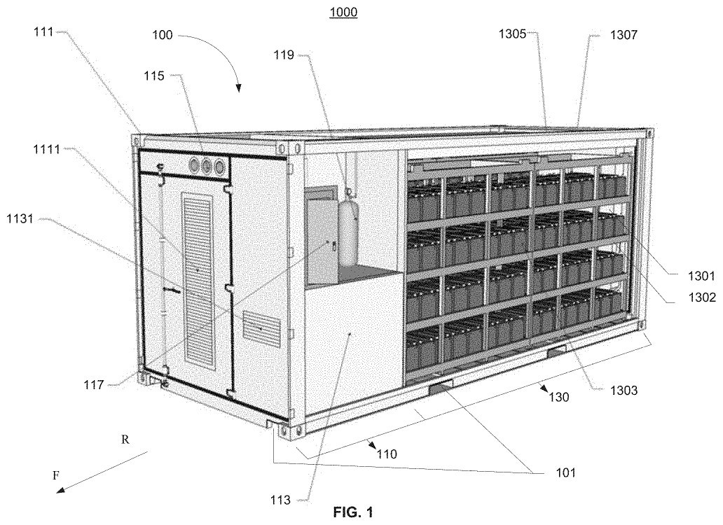

FIG. 1 is a left-front side perspective view 1000 illustrating an example battery-based energy storage device 100 in accordance with some implementations of the present disclosure. As shown in FIG. 1, the battery-based energy storage device 100 includes an energy storage inverter 111, a transformer 113, a fire extinguisher system 119, a distribution panel of auxiliary system 117, an AC wiring 115 connected to the energy storage inverter 111 and/or the transformer 113, a heat dissipation of energy storage inverter 1111 connecting to the energy storage inverter 111, a heat dissipation of transformer 1131 connected to the transformer 113, a first battery chamber 1301, a ventilation opening of battery 1305, and an air conditioner of battery 1307.

In some implementations, the battery-based energy storage device 100 includes an operating portion 110 and a battery storage portion 130. The energy storage inverter 111, the transformer 113, the fire extinguisher system 119, the distribution panel of auxiliary system 117, the AC wiring 115, the heat dissipation of energy storage inverter 1111, the heat dissipation of transformer 1131 are formed in the operating portion 110. The first battery chamber 1301 including a first battery rack 1302 and the first battery bank 1303, the ventilation opening of battery 1305, and the air conditioner of battery 1307 are formed in battery portion 130. In this way, the heat dissipation system of the operation portion 110 (i.e. the heat dissipation of energy storage inverter 1111 and the heat dissipation of transformer 1131) and the air conditioner system of the battery portion 130 (i.e. the ventilation opening of battery 1305 and the air conditioner of battery 1307) are separated in opposite side of the battery-based energy storage device 100 and air-flow independent. Since operation instruments (i.e. the energy storage inverter 111, the transformer 113, and the fire extinguisher system 119) in the operation portion 110 do not need the air conditioner, this separation arrangement may provide more efficient cooling and reduce thermal energy exchanges between the operating portion 110 and the battery portion 130.

In some implementations, the energy inverter 111 sets in a right-front side of the operation portion 110, and the transformer 113 and the fire extinguisher system 119 set in a left-front side of the operation portion 110. Furthermore, since the fire extinguisher system 119 and the transformer 113 are not huge objects comparing to the energy inverter 111, the fire extinguisher system 119 may be set above the transformer 113 for better space efficiency.

In some implementations, the battery-based energy storage device 100 includes a bottom trench 101 which is used for easier transportation. The design of the bottom trench 101 may provide an easier way for a crane or a forklift to move the entire battery-based energy storage device 100.

In some implementations, the battery-based energy storage device 100 is substantially the same size as a standard 20 ft container. The exterior dimensions of the battery-based energy storage device 100 is around 20 ft (or 6058 mm) in length×8 ft (or 2438 mm) in width×8.5 ft (or 2591 mm) in height. It should be noted that any slightly different in size, or tolerance should be seen as “substantially the same”. The design of the dimension enables the battery-based energy storage device 100 to be shipped around the world easily.

### Chamber Design

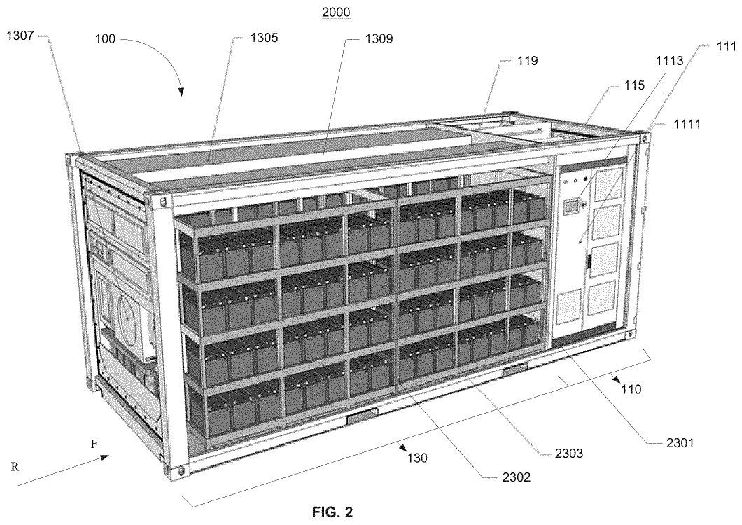

FIG. 2 is block diagram illustrating a right-rear side perspective view 2000 of the example battery-based energy storage device 1000 in accordance with some implementations of the present disclosure.

In some implementations, the battery-based energy storage device 100 further includes a second battery chamber 2301 which includes a second battery rack 2302 and a second battery bank 2303. In some implementations, the first battery bank 1303 and the second battery bank 2303 are arranged only one battery depth so that the operator does not need to get inside of the battery bank to replace or expand new battery banks. In some implementations, the battery chamber has a depth of 600-800 mm.

In some implementations, the air conditioner of battery 1307 is set at a sidewall of the battery-based energy storage device 100 and the ventilation opening of battery 1305 is set at top of the battery-based energy storage device 100 so that it creates an efficient air flow within the battery racks for cooling the battery banks.

### Independent Battery Chamber

In some implementations, the battery-based energy storage device 100 further includes a middle space 1309 which separates the first battery chamber 1301 and the second battery chamber 2301. The first battery chamber 1301 and the second battery chamber 2301 are separated and with independent air conditioning. In this way, when one of the first battery chamber 1301 and the second battery chamber 2301 is not in use, the air conditioner of battery 1307 may close to provide cooling to one chamber which saves more energy. This design also provides a better capability of expansion considered by users. In some implementations, a width of the middle space 1309 is less than 120 mm. In some implementations, the middle space 1309 may also set for circuits of the battery system or fire extinguisher channels.

In some implementations, the distribution panel of auxiliary system 117 is set at the left side of the battery-based energy storage device 100 (shown in FIG. 1) and next to the fire extinguisher system 119, and the panel of energy storage inverter 1113 is set at the right side of the battery-based energy storage device 100 (shown in FIG. 2) so that these panels may be operated at the outside of the device. The non-walk-in design prevents the operator from being trapped inside the battery-based energy storage device 100.

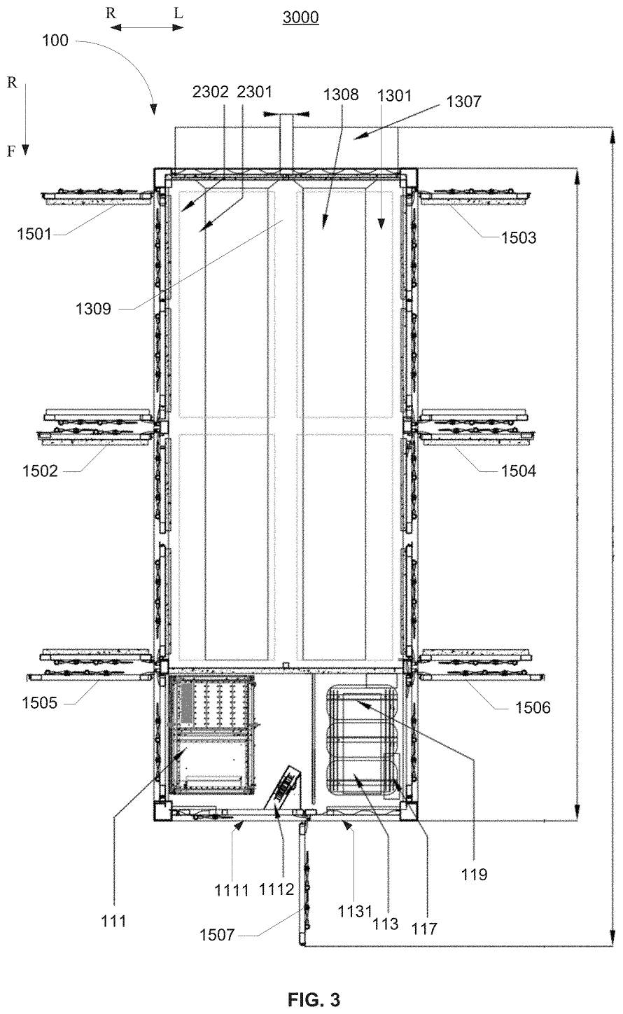

FIG. 3 is block diagram illustrating a top perspective view 3000 of an example battery-based energy storage device 1000 in accordance with some implementations of the present disclosure.

As shown in FIG. 3, the battery-based energy storage device 100 includes a first right side door 1501 associated with the second battery chamber 2301, a second right side door 1502 associated with the second battery chamber 2301, a first left side door 1503 associated with the first battery chamber 1301, a second left side door 1504 associated with the first battery chamber 1301, a right side panel door 1505 associated with the panel of energy storage inverter 1113, a left side panel door 1506 associated with the distribution panel of auxiliary system 117, and a front side door 1507 associated with the heat dissipation of energy storage inverter 1111. With these doors, the entire battery-based energy storage device 100 may be enclosed as a container without protruding parts, and thereby is very suitable for transportation without being containment, dusted, or damaged. In some implementations, the doors 1501-1507 may be hinged doors, which is better for airtight and space saving. In some implementations, the battery-based energy storage device 100 may be or enclosed by a 20 ft container with the protection class of NEMA 3R enclosures which is suitable for transportation. The dimension of the container may the same as standard or high cube 20 ft container depending on the battery.

### Heat Dissipation System

In some implementations, the heat dissipation of energy storage inverter 1111 and the heat dissipation of transformer 1131 are heat dissipation system installed on the front side of the battery-based energy storage device 100. In some implementations, it may also include a ventilation fan 1112 for the heat dissipation of energy storage inverter 1111. Since all the ventilation fans and heat dissipations are installed within the battery-based energy storage device 100, no protruding part is installed outside of the battery-based energy storage device 100, which makes it suitable for transportation and use in combination with other standard containers.

### Air Conditioner System

In some implementations, the air conditioner 1307 is set at the outside of the first battery chamber 1301 and the second battery chamber 2301. The air conditioner 1307 provides cooling air through two aircon ducts 1308 into the battery chambers. As mentioned above, this separated airflow design is highly energy saving and good for future battery expansion if one chamber is not in use.

### Energy Storage Inverter System

In some implementations, the energy storage inverter 111 is used to convert the DC power from the battery banks 1303 and 2303, to AC power to the AC distribution system in discharging mode, and vice versa in charging operation. In some implementations, the energy storage inverter 111 may work in two modes: (1) Utility-interactive mode, aka P-Q mode; and (2) Stand-alone mode, aka off-grid mode, or V-F mode.

(1) Utility-Interactive Mode (P-Q Mode)

The P-Q mode is that the reference voltage and a constant frequency may be provided by another source (usually the utility grid), and the active power and the reactive power can be commanded to change on the inverter.

(2) Stand-Alone Mode (V-F Mode)

The V-F control mode is that no matter how the inverter power change does, the amplitude and frequency of output voltage would be constant, the inverter of V/F control can provide voltage and frequency support for the micro-grid during islanded operation.

The inverter may act as a voltage source. The current amplitude and PF may be determined by the sum of the generation (if exist) and the consumption load.

### Transformer System

In some implementations, the transformer 113 may be a step-up isolation transformer which is used to adapt the 400V inverter to the 480V distribution system, which is assembled with UL-certified materials.

### Battery Banks

In some implementations, the battery banks 1303 and 2303 may be lithium iron phosphate (LFP) which is recommended, or lithium nickel manganese cobalt oxide (LiNiMnCoO₂ or NMC) if the end user prefers. The energy density of battery varies, typically, the maximum battery capacity of LFP in a 20 ft container may be around 1 MWh.

### Heating, Ventilation, and Air Conditioning (HVAC) System

In some implementations, the operation system (i.e. the energy inverter 111 and the transformer 113) does not require an air conditioner system 1307, yet the battery banks 1303 and 2303 (if the battery banks are batteries such as LFP batteries) may require an air conditioning system to keep the internal ambient temperature stable. The air conditioner system 1307 may be installed at the rear side of the battery-based energy storage device 100 as disclosed above.

### Fire Extinguisher System

In some implementations, the fire extinguisher system 119 may be preinstalled, depending on the end user's demand. The fire extinguisher system 119 shall consist with local laws or regulations, example: NFPA regulations if the project is in the US.

### DCDC Converter

The back-up power may need charging just as diesel generators require refueling. The battery banks 1303 and 2303 may be charged by the energy storage once it is connected to the utility grid. There are also other ways to charge the battery bank. In some particular application scenario, for example, a PV carport can also be used to charge the battery, as long as there are DC-DC converters deployed. In some implementations, the DC-DC converters have an MPPT algorithm built in and may optimize the output power from the solar power.

In some implementations, for example, in the 250 kW or smaller system, the DC-DC converters (not shown) may be integrated into the battery-based energy storage device 100.

In some implementations, for example, in the 500 kW system or larger system. The DCDC converter (not shown) must be deployed on the ground.

### Single Line Diagram of Energy Storage System (ESS) Container

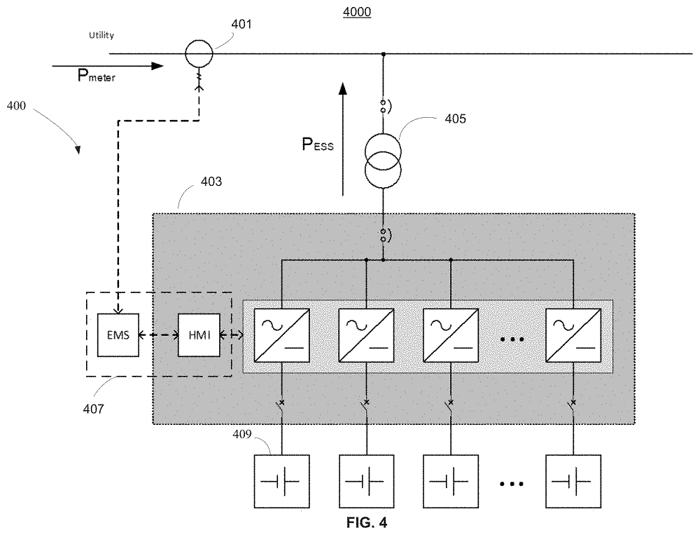

FIG. 4 is block diagram illustrating multi-string topologic of an example energy storage system 400 in accordance with the implementations of the present disclosure.

In some implementations, as shown in FIG. 4, the energy storage system 400 is configured to detect a demand of power supply from a power grid, to determine a power string needed, to receive the power string from one or the plurality of battery bank, to invert DC power of the power string from the battery banks to AC power of the energy storage system, and to transform AC power of the energy storage system to AC power of the power grid. To be more specific, the energy storage system 400 includes a current transformer or a meter 401, an energy storage inverter system 403, and an external transformer 405.

In some implementations, the meter 401 is configured to detect the demand of the power supply (i.e. a utility grid or a micro-grid during islanded operation) and transmit the collected data to the energy storage inverter system 403.

In some implementations, the energy storage inverter system 403 includes a human machine interface (HMI) system 407 which includes an HMI and an energy management system (EMS). In other implementations, the EMS may be replaced by any compatible external EMS. In some implementations, the energy storage inverter system 403 is configured to receive one or a plurality of battery bank string (i.e. battery bank string 409). After the demand of the power supply is determined, the energy storage inverter system 403 may connect to one or the plurality of battery banks and receiving power from the battery banks. The energy storage inverter system 403 may invert the DC power from the battery banks to AC power, and transmit the AC power to the external transformer 405. The external transformer 405 may then transform the AC power from the energy storage inverter system 403 to the AC power of the demand of power grid.

### Multi-String Modules

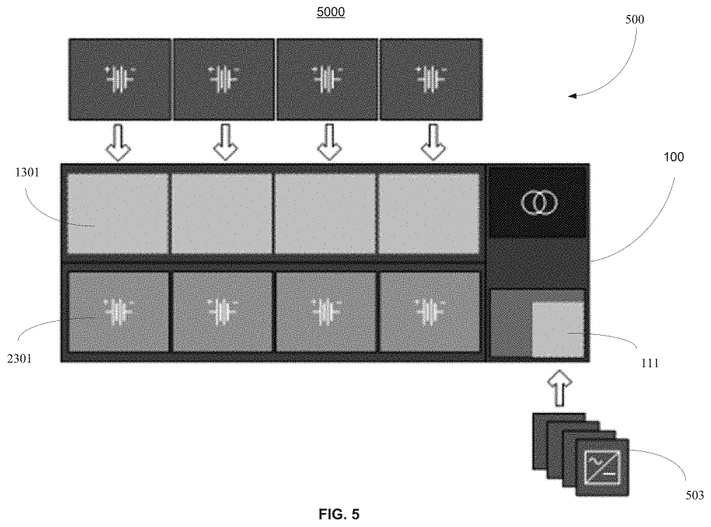

FIG. 5 is a block diagram illustrating multi-string modules included in the example energy storage system 400.

As shown in FIG. 5, as mentioned above, the battery-based energy storage device 100 includes a first battery chamber 1301, the second battery chamber 2301, and the energy inverter 111. With the multi-string module, the battery banks in different strings may be de-coupled by inverter modules 503 built within the energy inverter 111. All the battery banks in the battery-based energy storage device 100 are not parallelly connected. By this means, new battery banks and old battery banks may be used together, and different voltage battery banks may be mixed used.

Consequently, the end user may choose to install a small system for the first step, once they have higher power and energy demand to install more, they may just add up with new battery banks and inverter modules 503, without concerning about the mixing-up of new and pre-installed battery banks.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It may also be understood that, although the terms “first,” “second,” etc. may be used herein to describe various elements, these elements should not be limited by these terms. These terms are only used to distinguish one element from another. For example, a first door could be termed a second door, and, similarly, a second door could be termed the first door, without changing the meaning of the description, so long as all occurrences of the “first door” are renamed consistently and all occurrences of the “second door” are renamed consistently. The first door and the second door are both doors, but they are not the same door.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It may also be understood that the term “and/or” as used herein refers to and encompasses any and all possible combinations of one or more of the associated listed items. It may be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It may be evident, however, to those skilled in the art that implementations of the inventive subject matter may be practiced without these specific details. In general, well-known instruction instances, protocols, structures, and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

1. A battery-based energy storage device comprising:
an energy storage inverter;
a transformer;
a fire extinguisher system;
a first battery chamber;
a second battery chamber, wherein the first battery chamber and the second battery chamber are separated by a wall structure and each has independent air conditioning; and
an air conditioner system is configured to include (1) a first air conditioning unit configured to provide air conditioning to the first battery chamber and (2) a second air conditioning unit configured to the second battery chamber, wherein the first air conditioning unit is configured to provide air conditioning to the first battery chamber when the second air conditioning unit does not provide air conditioning to the second battery chamber; and the second air conditioning unit is configured to provide air conditioning to the second battery chamber when the first air conditioning unit does not provide air conditioning to the first battery chamber, wherein a size of the battery energy storage device is substantially the same as a standard 20 ft container;
wherein the air conditioner system includes a heat dissipation unit installed on a back side wall of the battery-based energy storage device and does not protrude from the back side of the battery-based energy storage device; and
wherein the battery-based energy storage device including no hardware units protruding from any other side wall or top wall of the battery-based energy storage device;
a heat dissipation of the energy storage inverter;
a heat dissipation of the transformer;
a distribution panel of an auxiliary system;
AC wiring connected to the energy storage inverter;
a first right side door providing access to the second battery chamber;
a second right side door providing access to the second battery chamber;
a first left side door providing access to the first battery chamber;
a second left side door providing access to the first battery chamber;
a right side panel door providing access to a control panel of energy storage inverter;
a left side panel door providing access to the distribution panel of the auxiliary system; and
a front side door providing access to the heat dissipation of the energy storage inverter;
wherein the second right side door, the first left side door, the right side panel door, the left side panel door, and the front side door all open either sideways or outwards away from an inner side of the battery energy storage device.

2. The battery-based energy storage device as claimed in claim 1, wherein dimensions of the battery energy storage device is 20 ft×8 ft×8.5 ft.

3. The battery-based energy storage device as claimed in claim 1, wherein a width of the first battery chamber, the second battery chamber, and the wall structure is equal to an inner width of the battery energy storage device.

4. The battery-based energy storage device as claimed in claim 1, further comprises a ventilation opening set at a top of the first battery chamber or the second battery chamber.

5. The battery-based energy storage device as claimed in claim 1, wherein a depth of the first battery chamber and a depth of the second battery chamber is between 600 and 800 mm.

6. The battery-based energy storage device as claimed in claim 1, wherein a width of the wall structure if less than 120 mm.

7. (canceled)

8. (canceled)

9. (canceled)

10. (canceled)

11. (canceled)

12. The battery-based energy storage device as claimed in claim 1, further comprises:
an operating portion; and
a battery portion,
wherein the energy storage inverter, the transformer, the fire extinguisher system, the heat dissipation of the energy storage inverter, the heat dissipation of the transformer, the distribution panel of the auxiliary system, and the AC wiring are set in the operating portion,
wherein the first battery chamber, the second battery chamber, and an air conditioner system are set in a battery portion, and
wherein the operating portion and the battery portion are air-flow independent.

13. The battery-based energy storage device as claimed in claim 1, further comprises:
an energy storage system configured to detect a demand of power supply from a power grid, to determine a power string needed, to receive the power string from one or the plurality of battery bank, to invert DC power of the power string from the battery banks to AC power of the energy storage system, and to transform AC power of the energy storage system to AC power of the power grid.

14. The battery-based energy storage device as claimed in claim 13, wherein the energy storage system comprises:
a meter;
an energy storage inverter system; and
an external transformer.

15. The battery-based energy storage device as claimed in claim 14, wherein the meter is configured to detect the demand of the power supply from the power grid and transmit collected data to the energy storage inverter system.

16. The battery-based energy storage device as claimed in claim 14, wherein the energy storage inverter system comprises:
a human machine interface (HMI) and an energy management system (EMS), wherein the energy storage inverter system is configured to receive the power string from one or the plurality of battery bank, to invert the DC power from the battery banks to the AC power, and to transmit the AC power to the external transformer.

17. The battery-based energy storage device as claimed in claim 16, wherein the external transformer is configured to transform the AC power from the energy storage inverter system to the AC power of the demand of power grid.

18. The battery-based energy storage device as claimed in claim 1, includes a supporting structure capable of supporting a second battery-based energy storage device on top of the battery-based energy storage device.

19. The battery-based energy storage device as claimed in claim 1, wherein all components of the battery-based energy storage device are configured to be serviceable by a user from outside of the battery-based energy storage device.

20. The battery-based energy storage device as claimed in claim 1, wherein the first battery chamber and the second battery chamber are configured to work by itself without one another.
